(19) United States
(12) Patent Application Publication
(10) Pub. No.: US 2010/0133172 A1
(43) Pub. Date: Jun. 3, 2010

(54) Fouling resistant coating for membrane surfaces

(76) Inventors: Qun Song, Gurnee, IL (US); Jane Chiao Li, Arlington Heights, IL (US)

Correspondence Address: Dr. Song, NL Chemical Technology, Inc, Suite 100, 479 Business Center Dr., Mount Prospect, IL, 60056, US

(21) Appl. No.: 12/315,227

(22) Filed: Dec. 1, 2008

(51) Int. Cl. B01D 65/08; B01D 71/60; B01D 71/66; C08L 79/02; C08L 71/00; C08L 81/06

(52) U.S. Cl. 210/500.37; 210/500.21; 525/540; 525/61; 525/535

(57) ABSTRACT

A coating that exhibits resistance to fouling by waterborne contaminants, and permselective membranes having this type of coating, are disclosed. For example, a reverse osmosis membrane is coated with a hydrogel-like composition comprising a combination of a hydrophilic polymer, a polyphenolic compound, and a surfactant, whereby the membrane is made more resistant to fouling by organic contaminants. Particularly beneficial are coating compositions containing amine-based surfactants, these being retained in the hydrophilic coating by polar or ionic binding forces.

### BACKGROUND OF THE INVENTION

The present invention relates generally to permselective membranes and relates more particularly to permselective membranes having a resistance to fouling by aqueous borne contaminants.

It is known that certain permselective membranes can distinguish between dissolved substances in aqueous media and, in fact, between such dissolved substances and the aqueous solvent itself, i.e., water. Such membranes are useful to selectively permeate either the aqueous solvent itself, such as by the process termed “reverse osmosis”, or one or more the dissolved substances by processes including reverse osmosis, nanofiltration, ultrafiltration, microfiltration, dialysis, pervaporation, facilitated transport, and perstraction. In some of these methods, primary emphasis may be placed on transport of the aqueous solvent itself, with or without one or more of the dissolved substances. In some of these processes, selective permeation of one or more of the dissolved substances exclusively or with minimal transport of the aqueous solvent may be emphasized. In reverse osmosis, purified water is often the permeating species desired by the practitioner. In some of the latter processes mentioned above, permeation of a nonaqueous species exclusive to the aqueous solvent may be desired result. For example, passage of ethanol through a membrane exclusively from a water-ethanol blend would be a highly desirable separation in the production of ethanol as a fuel.

A common problem encountered in the processing of aqueous media by permselective membranes is the fouling of the membrane surfaces by substances in the aqueous media. Fouling may be caused by a variety of species, including dissolved species, colloidal species, suspended matter, surfactants or surfactant-like chemicals, microbiological entities, and the like. Fouling may consist of deposition of one or a combination of these species as a layer on the active surface of the permselective membrane, reducing the effectiveness of the active layer of the permselective membrane. Any one of these membrane processes that selectively permeates the aqueous solvent engenders an additional complication, in that potentially fouling species in the aqueous media are selectively concentrated at the active surface of the permselective membrane, increasing the propensity to fouling due to the increased concentration of the foulants thereat. For example, reverse osmosis membrane systems in commercial usage are commonly designed to permeate from 30% to as much as 95% of the water in the feedstream, providing a high yield of product water versus incoming feedwater, i.e., exhibiting high recovery rates. Where potable water is derived from seawater by reverse osmosis, the high initial concentration of salt in the incoming seawater commonly limits the product water recovery rate to the lower end of the range, while converting the remainder of the incoming seawater feed into a more concentrated brine. In the case of a low TDS (total dissolved solids) tapwater, wherein reverse osmosis may be utilized to provide purified water of exceptional quality for intended uses such as semiconductor chip manufacturing processes, very high recovery rates are possible. At any place in this range of concentration, membrane fouling may be exacerbated by surficial concentration of the foulants. But even in the absence of a concentrating step in the permselective membrane separation process, water-borne species may selectively adsorb to and foul the active surface layer of the permselective membrane.

It is generally presumed that fouling by water-borne species is promoted or augmented by the presence of hydrophobic sites on the active surface of a membrane. During the 1970s, a study of fouling of reverse osmosis membranes by municipal effluent was conducted in a facility called Water Factory 21 in Orange County, California, wherein the municipal wastewater was extensively pretreated by a combination of purification steps to provide a suitable feedwater for reverse osmosis processing. Development of a biological surface deposit on the reverse osmosis membranes was documented by Ridgeway and co-workers (“Bacterial Adhesion and Fouling of Reverse Osmosis Membranes”, J. Am. Water Works Assoc., Vol. 77, p 97ff, 1985). A comparison of various membranes in that study appeared to indicate the importance of hydrophobic sites as being initiating sites for colonization and development of biofilms. It is also well known that ultrafiltration membranes, which are commonly prepared from hydrophobic polymers such as polysulfone and polyethersulfone, are quite susceptible to fouling by biological products such as proteinaceous species, and that the size selectivities of such membranes are modified by this fouling process. Surface pore diameters may even be changed by the deposition of adsorbent foulants on the pore walls. These and similar findings have caused makers of such ultrafiltration and reverse osmosis membranes to seek to develop permselective membranes with hydrophilic surfaces. In U.S. Pat. No. 7,125,493, for example, polysulfone-based ultrafiltration membranes have been disclosed, wherein a hydrophilic polymer compatible with the polysulfone has been combined with the polysulfone in the original membrane manufacturing recipe. Such a polymer is represented, for instance, by polyvinylpyrrolidone. Various membranes have also been surface-treated by the grafting of hydrophilic monomers to their surfaces via free radical processes (U.S. Pat. Nos. 4,845,132, 5,468,390). In the case of reverse osmosis, coating with hydrophilic polymers has also been considered. For instance, U.S. Pat. No. 6,177,011 discloses the coating of reverse osmosis membrane surfaces with a layer of polyvinyl alcohol as a method of increasing surface hydrophilicity and promoting fouling resistance. Also recently disclosed in U.S. Pat. No. 6,913,694 is a process of modifying surface hydrophilicity by reacting the surface of a reverse osmosis membrane with polyfunctional epoxy compounds.

### SUMMARY OF THE INVENTION

It is an object of the present invention to provide a novel fouling resistant permselective membrane.

It is another object of the invention to provide a coating that may be applied to various types of permselective membranes, wherein the coating resists fouling by fouling contaminants in aqueous media.

It is yet another object of the present invention to provide novel reverse osmosis membranes that possess improved fouling resistance by reason of such coatings contained thereon.

It is a further object of the invention to provide a coating that can exhibit resistance to fouling by specifically identified foulants.

It is yet a further object of the invention to provide a fouling resistant coating that can be treated in situ to restore its resistance to fouling on a periodic basis.

The present invention provides permselective membranes with reduced fouling potential, and thereby increased effectiveness in permselective separations, wherein the permselective membranes contain a novel coating applied to their active surfaces, i.e., the surfaces that come into contact with aqueous feedstreams containing potentially fouling substances. The coating comprises a hydrophilic polymer matrix having associated therewith one or more surface-active agents, this combination being applied to the active surface of the permselective membrane not for the purpose of conferring permselectivity, but rather for the purpose of conferring improved resistance to fouling. In the coating, the surface-active agent is selected such that hydrogen bonding forces and/or chain entanglement forces tend to hold the surface-active agent in place during operation of the thus-coated membrane in permselective separations. Bonding of the surface-active agent within the hydrophilic polymer matrix may additionally or otherwise entail the presence or blending of other organic or inorganic agents in the hydrophilic polymer matrix, where such additives also jointly or separately promote fixation of the surface-active agent within the matrix. For instance, an amine-based surface-active agent is held within a hydrophilic polymer matrix such as polyvinyl alcohol, wherein also a polyfunctional phenolic compound such as tannic acid provides additional acid-base binding forces relative to the amine function in the surface-active agent. In its broadest embodiment therefore, the invention comprises a membrane having a coating deposited and insolubilized thereon, wherein the coating comprises a hydrophilic polymeric matrix and a surface-active agent, said surface-active agent held within the polymer matrix by one or more bonding forces, wherein the combination of the hydrophilic polymeric matrix and the surface-active agent or agents resists fouling by contaminants in a feedstream being operated upon in a permselective membrane separation.

### DETAILED DESCRIPTION OF THE INVENTION

The present invention is directed toward a means of preventing or reducing loss of performance by a permselective membrane in a separation process due to fouling of an active surface of the permselective membrane due to the deposition of one or more foulants from a feedstream in contact with the membrane's surface. The invention resides in a coating that may be applied to the active surface of a permselective membrane and affixed thereto by drying or other means, thereby providing increased fouling-resistance. The present invention accordingly also includes permselective membranes incorporating said coatings. The present invention most particularly includes reverse osmosis and nanofiltration membranes, preferably of the class of thin film composite membranes such as exemplified in U.S. Pat. Nos. 4,277,344, 4,872,984, 4,039,440, and 6,162,358, all of which are incorporated in their entirety herein by reference. The coating normally consists of a combination of at least the following two ingredients: a hydrophilic polymer and a surface-active agent. The hydrophilic polymer forms a matrix and the surface-active agent is embedded in the hydrophilic polymeric matrix. Other ingredients may be specifically included in the matrix as well. Combinations of hydrophilic polymers and surface-active agents are chosen in the context of this invention on the basis that the surface-active agents will tend to remain in place within the hydrophilic polymeric matrices during actual operation of the permselective membrane so coated in their intended application, i.e. membrane separations. Furthermore, these combinations allow for the replenishment of the presence and concentration of one or more such surface-active agents in the hydrophilic polymeric matrices by means of post-treatment, depending upon possible elution of surface-active agents into feedstreams flowing over the permselective membrane's fouling-resistant coating.

The hydrophilic polymeric matrix may generally consist of a single hydrophilic polymer or may be constituted from two or more polymers in combination. Hydrophilicity may vary between the polymers when two or more are combined. Hydrophilicity is used herein in its normally accepted usage in the English lexicon. Hydrophilic polymers are normally wettable by water, and may range in solubility in water from completely soluble at room temperature, to completely soluble in hot water, to only partial solubility in water, to spontaneous dispersion in water without forming true solutions. Hydrophilic polymeric coatings themselves would preferably swell in water at room temperature, but not dissolve in water. It is well within the art of polymer science to prepare a polymer solution in water, coat the solution onto a surface, and dry the surface in such a manner that the polymer does not spontaneously re-dissolve on contact with water, while retaining hydrophilicity in the polymeric matrix. This may involve crosslinking of the hydrophilic polymer chains via chemical reaction by added agents reactive toward the hydrophilic polymers.

Examples of hydrophilic polymers that may be used in this invention include, but are not limited to, polyvinyl alcohol, hydroxyethylcellulose, hydroxypropylcellulose, methylcellulose, poly(hydroxyethyl methacrylate) and its copolymers, styrene-maleic anhydride copolymer, methyl vinyl ether-maleic anhydride copolymer, other maleic anhydride copolymers, polyacrylic acid, polyethylenimine, carboxymethyl cellulose, locust bean gum, guar gum, carrageenan, agar, polyvinylpyrrolidone, sulfonated polysulfone, polyethylene oxide and its copolymers. For improved fouling resistance, preferred polymers will generally be free of ionic groups and contain minimal presence of polymeric segments that are not hydrophilic. Particularly advantageous as hydrophilic polymers are polyhydroxylic polymers, such as represented by polyvinyl alcohol and its copolymers and cellulosic derivatives, including cellulosic polymers rendered normally water-soluble or water-dispersible via chemical modification. Most preferred are highly hydrolyzed polyvinyl alcohol polymers. Such polymers are normally generated through polymerization of vinyl acetate, followed by saponification of pendant acetate groups, wherein at least 85% of pendant acetate groups and most preferably about 95% or more of such groups have been converted to pendant hydroxyl groups via hydrolysis. Particularly preferred in this invention are highly hydrolyzed grades of polyvinyl alcohol, which are characterized as being hot-water-soluble.

In this invention, the hydrophilic polymer is advantageously prepared as a solution in a solvent. Water is customarily employed as the solvent of choice, but co-solvents may also be employed, such as including but not limited to: methanol, ethanol, isopropanol, acetone, acetic acid, dimethylsulfoxide, or blends of these solvents. These or any alternate co-solvents are preferably volatile, such that drying conditions that would evaporate water will also evaporate most or all of the co-solvent as well. Stirring is customarily utilized, and heating may be applied to the solvent to promote dissolution of the hydrophilic polymer in a timely fashion. Methods of dissolving these polymers are quite familiar to one of skill in the art of handling polymer solutions. In some cases, such as with highly hydrolyzed polyvinyl alcohol, manufacturers may also provide instructions regarding preferred methods of dissolving the polymers.

The surface-active agent that—in combination with the hydrophilic polymer—confers improved fouling resistance to the subsequently formed coating on a permselective membrane will normally be added to the polymer solution at a time when the polymer has been dissolved or otherwise dispersed into the solvent media. A commonly used term for denoting surface-active agents is “surfactants”. The surface-active agent is to be chosen on the basis of its affinity toward the hydrophilic polymer, or alternately toward one or more additives incorporated into the hydrophilic polymer matrix. Or alternatively, the surface-active agent may be chosen based on probable chain entanglement of the surface-active agent with the chains of the hydrophilic polymer in the coated matrix. The surface-active agent may be an ionic surfactant or a nonionic surfactant. Nonionic surfactants are generally preferred in this invention for the reason that some types of ionic groups may provide linkage sites for attachment of feedstream foulants. Particularly preferred are polyethoxylated compounds, wherein lengthy polyethylene oxide segments provide the water-loving ends of the surfactants. These types of surface-active agents, when present in the hydrophilic polymeric matrix, are useful in reducing the subsequent rate of fouling of membranes coated therewith. Fouling is normally characterized in this context as being a noticeable reduction in flux of a desired component in a feedstream applied to the membrane, but fouling may also include attributes of reduced separation selectivity and increased resistance to feedstream flow through a device containing the permselective membrane. Such devices may include spiral wound membrane cartridges, hollow fiber membrane cartridges, plate and frame assemblies, and the like. The overall effectiveness of a fouling-reducing coating may be judged in terms of either a reduction in loss of flux, or in terms of restoration of flux upon cleaning, or in terms of a combination of both phenomena.

The polymeric coating solution may contain from 0.1% by weight to as much as 90% by weight of the hydrophilic polymer in water or water-based solvent blend. The high end of the polymer concentration range may be reached by employing the polymer in the form of a latex suspension or the like. When the hydrophilic polymer is employed in a substantially dissolved state in water or water-based solvent blend, concentration range will generally range from 0.1% to 15% by weight in the coating solution. Surfactant concentration will generally range from 0.01% to as high as 10% by weight in the coating solution. Preferably, the surfactant's concentration will range from about 0.01% to about 5% by weight in the coating solution, more preferably from about 0.02% to about 2% by weight in the coating solution. The surfactant concentration may exceed the polymer concentration, such that the ratio of surfactant to hydrophilic polymer may range widely from much less than 1:1 to much greater than 1:1. Other ingredients may be included in the coating solution as well, including pH adjustment chemicals (acids, bases, or buffering compounds), dyes, and reactive chemicals for inducing crosslinking of the hydrophilic polymers. It is advantageous in some cases, for example, to insolubilize hydrophilic polymers by formation of acetal linkages as by inclusion of aldehydes that are reactive toward hydroxyl groups, particularly under catalysis by acids. Ingredients may also be added that promote retention of the surface-active agents within the hydrophilic polymeric matrix. Examples of ingredients particularly suitable for enhancing retention of the surface-active agents include polyfunctional phenolic compounds such as tannic acid, epicatechin, gallic acid, digallic acid, various gallates, and catechol. Wherein the surface-active agents comprise surfactants having amine groups as part of their structures, these phenolic compounds are particularly effective in enhancing their retention within the hydrophilic matrix. It has furthermore been observed that the combination of tannic acid with a hydrophilic polymer, for example, can promote a degree of fouling resistance in its own right, though to a lesser degree than a ternary combination of a hydrophilic polymer, tannic acid, and a surface-active agent.

The coating solution may be applied to the underlying membrane by any of several known processes, including dipping, spraying, knife-over-roll coating, roll-to-roll transfer coating, wire-wound-rod coating. The amount of coating will be generally dependent upon the desired thickness of the resultant coating after drying. The thickness of the dried coating may range preferably from about 0.02 micrometers (μm) to about 10:m, more preferably from about 0.05 μm to about 2.5 μm. The coating itself will likely engender some flux resistance to permeating species, such that the lower end of the thickness range of the coating may be most preferable. However, the degree of hydrophilicity of the coating, the amount of the surface-active agent or agents present in the coating, and the presence of other potential additives such as swelling agents may permit use of the middle or upper range of coating thicknesses when and as desired, as will be evident to one skilled in the art who adapts the invention disclosed herein to his or her underlying membrane. The applied solution will preferably undergo a drying step. Drying may be effected at ambient temperature such as room temperature, or at elevated temperature conditions. Drying temperatures of up to about 110 degrees Celsius may ordinarily be employed. In some instances higher temperatures than 110 degrees Celsius may be employed, particularly if a crosslinking reaction is being conducted in the coating composition, such as for instance crosslinking by acetal formation. The nature and composition of the underlying permselective membrane may limit the maximum temperature that can be employed in a drying step.

In subsequent operations wherein a thus coated permselective membrane is utilized for membrane separations, eventual elution of the surface-active agent into the feedstream may occur. In the scope of this invention, replenishment of lost surface-active agents is contemplated, whereby a surfactant-depleted coating can be exposed to a solution of fresh surface-active agent, imbibing fresh surfactant into the coating matrix. Advantageously, this replenishment may be conducted as part of a membrane cleaning treatment on some periodic basis consistent with the use of the permselective membrane in a separations process. Thus, a permselective membrane coated in accordance with the invention of this disclosure and thereafter assembled into a device such as a spiral wound membrane cartridge, hollow fiber membrane cartridge, plate and frame assembly, or the like, may be cleaned after some period of usage, by circulating a cleaning solution through the device. When the device has been suitably cleaned, the coated membrane contained therein can be treated with a soaking solution containing fresh surface-active agent, whereby the presence and concentration of the surface-active agent is renewed within the hydrophilic polymeric matrix. Alternatively, elution of the surface-active agent from the coating on the permselective membrane may be diminished or prevented by including within the feedstream a small concentration of the same surface-active agent. Within the scope of this invention, it is also contemplated that the permselective membrane may be coated with a coating comprising a hydrophilic polymer and a polyfunctional phenolic compound such as tannic acid, followed later by exposure to a solution containing the surface-active agent, from which latter solution the coating may be impregnated with the surface-active agent.

Turning now to the most preferred embodiment of the invention as envisioned at the time of this writing, a fouling-resistant coating is disclosed that comprises a combination of a highly hydrolyzed polyvinyl alcohol as the hydrophilic polymer and a polyethoxylated amine surfactant. Also included in this combination is tannic acid as an additive. Tannic acid is a natural occurring product containing phenolic groups (CAS Registry #1401-55-4). A suitable example of a highly hydrolyzed polyvinyl alcohol is Airvol 165 (trademark of Air Products Co.). A suitable polyethoxylated amine is Tetronic 904 (trademark of BASF). In this combination, the surfactant is believed to be constrained within the resulting hydrophilic polymeric matrix by chain entanglement with the polyvinyl alcohol, by hydrogen bonding between the phenolic groups of the tannic acid and both amine and ethyleneoxide segments of the surfactant, and also by hydrogen bonding forces between the polyvinyl alcohol and the amine groups of the surfactant.

### PREPARATION OF A PERMSELECTIVE MEMBRANE—COMPARATIVE EXAMPLE A

A permselective membrane was prepared according to the method described in U.S. Pat. No. 6,162,358, wherein the aqueous amine solution contained 2.5% meta-phenylenediamine, 0.2% sodium lauryl sulfate, 1.0% guaiacol and 3.0% of a sodium salt of camphorsulfonic acid. The top surface of a porous polysulfone substrate was contacted with the aqueous amine solution for 8 seconds, then drained for approximately 20 seconds. Excess amine solution was removed by rolling the top surface with a squeegee roller. The top surface was then allowed to dry in air for a 2-minute period. The top surface was then contacted with a nonaqueous solution of 0.15% by weight trimesoyl chloride in Isopar G (trademark of Exxon Corp) for a period of 8 seconds. The resulting membrane was drained for 1 minute, then dried in an oven at 90° C. for 4 minutes. It was washed in a water bath for 10 minutes, followed by a dip in a 7.5% glycerol solution, then re-dried. The resulting permselective membrane was then placed in a test cell for reverse osmosis testing with the 1500 ppm aqueous sodium chloride (NaCl). This membrane exhibited a flux of 52.5 gfd and a salt rejection of 99.0%, tested at 225 psi and 25° C.

### PREPARATION OF COMPARATIVE EXAMPLE B

A permselective membrane was prepared by the method described above, but prior to the final drying, the membrane was coated with a solution containing 0.1% Airvol 165. This comparative example represents a membrane with purported nonfouling characteristics prepared according to U.S. Pat. No. 6,177,011. Under the same reverse osmosis test conditions, this membrane showed 37.2 gfd and 99.3% salt rejection.

### PREPARATION OF A FOULING RESISTANT MEMBRANE—EXAMPLE 1

A permselective membrane was prepared by the method described above, but prior to the final drying, a coating solution containing 0.1% Airvol 165 and 1% tannic acid was applied to the membrane, and the excess solution was removed to form a thin layer of the coating solution on the membrane surface. It was then re-dried at 90° C. for 4 minutes. Membrane performance was evaluated in a reverse osmosis test cell as before. This membrane exhibited a flux of 38.9 gfd and a salt rejection of 99.0%, tested with 1500 ppm NaCl at 225 psi and 25° C.

### PREPARATION OF A FOULING RESISTANT MEMBRANE—EXAMPLE 2

A permselective membrane was prepared by the method described above, but prior to the final drying, a coating solution containing 0.1% Airvol 165, 1% tannic acid, and 0.015% (150 ppm) Tetronic 904 surfactant was applied to the membrane surface, and the excess solution was removed to form a thin layer of the coating solution on the membrane surface. It was then re-dried at 90° C. for 4 minutes. Membrane performance was evaluated in a reverse osmosis test cell as before. This membrane exhibited a flux of 38.0 gfd and a salt rejection of 99.2%, tested with 1500 ppm NaCl at 225 psi and 25° C.

The fouling characteristics of Examples 1 and 2 and the two comparative examples were evaluated by simulated fouling tests employing tannic acid as the fouling species in the aqueous feedstream. (The tests were not all conducted simultaneously.) During the fouling test, initial flux readings were taken after one hour and at 19 hours into the test. The membranes were then cleaned in place by circulation of a solution of 1.0 wt % trisodium phosphate solution for 1 to 1.5 hours. The cleaned membranes were then tested for flux and salt rejection with 1500 ppm NaCl at 225 psi. Results are shown in Table 1.

In these results, the membrane with the coating as per Example 1 showed rather good flux retention at 84%, while the membrane with the coating as per Example 2 showed almost complete flux retention (93%) after fouling and cleaning, whereas Comparative membranes A and B lost 36% and 42% of their flux respectively. The performance of Example 2 wherein the surface-active agent was present in the coating was particularly effective in resistance to fouling.

TABLE 1

| | Comparative | Comparative | Nonfouling | Nonfouling |
|---|---|---|---|---|
| | Membrane A | Membrane B | Example 1 | Example 2 |
| Initial flux | 52.5 gfd | 37.2 gfd | 38.9 gfd | 38.0 gfd |
| Initial salt | 99.0% | 99.3% | 99.0% | 99.2% |
| rejection | | | | |
| Tannic acid - | 41.2 gfd | 27.4 gfd | 35.2 gfd | 35.8 gfd |
| 1 hr | | | | |
| Tannic acid - | 29.5 gfd | 17.3 gfd | 25.1 gfd | 28.1 gfd |
| 19 hr | | | | |
| Post-cleaning | 33.5 gfd | 21.4 gfd | 32.6 gfd | 35.5 gfd |
| flux | | | | |
| Final salt | 99.3% | 99.6% | 99.2% | 99.3% |
| rejection | | | | |
| Flux retention | 64% | 58% | 84% | 93% |

The invention disclosed herein is not to be limited by the examples shown above but rather by the breadth of the disclosure, including variations and modifications that are within the scope of the claims appended hereto.

1. A coating for conferring fouling resistance to a permselective membrane, comprising a hydrophilic polymer matrix and a surface-active agent associated therewith, said coating being applied to and insolubilized upon an active surface of the permselective membrane.

2. The coating of claim 1 wherein the surface-active agent comprises an amine-containing surfactant.

3. The coating of claim 2 wherein the surfactant comprises a polyethoxylated aliphatic polyamine.

4. The coating of claim 2 wherein the coating contains a phenolic compound.

5. The coating of claim 4 wherein the phenolic compound comprises tannic acid.

6. The coating of claim 2 wherein the hydrophilic polymer comprises a member of the group containing polyvinyl alcohol, hydroxyethylcellulose, hydroxypropylcellulose, methylcellulose, poly(hydroxyethyl methacrylate), hydroxyethyl methacrylate copolymers, styrene-maleic anhydride copolymer, methyl vinyl-maleic anhydride copolymer, polyacrylic acid, polyethylenimine, carboxymethyl cellulose, locust bean gum, guar gum, carrageenan, agar, polyvinylpyrrolidone, sulfonated polysulfone, polyethylene oxide, and polyethylene oxide copolymers.

7. The coating of claim 5 wherein the hydrophilic polymer comprises polyvinyl alcohol.

8. The coating of claim 1, wherein said coating comprises a blend of a polyvinyl alcohol, tannic acid, and an amine-containing surface-active agent.

9. A permselective membrane having improved resistance to fouling, comprising a permselective membrane having a coating on an active surface thereof, the coating comprising a hydrophilic polymer matrix and a surface-active agent associated therewith, said coating being applied to and insolubilized upon an active surface of the permselective membrane.

10. The membrane of claim 9 wherein the coating contains a surface-active agent comprising an amine-containing surfactant.

11. The membrane of claim 10 wherein the surfactant comprises a polyethoxylated aliphatic polyamine.

12. The membrane of claim 11 wherein the coating contains a phenolic compound.

13. The membrane of claim 12 wherein the phenolic compound comprises tannic acid.

14. The membrane of claim 9 wherein the hydrophilic polymer comprises a member of the group containing polyvinyl alcohol, hydroxyethylcellulose, hydroxypropylcellulose, methylcellulose, poly(hydroxyethyl methacrylate), hydroxyethyl methacrylate copolymers, styrene-maleic anhydride copolymer, methyl vinyl-maleic anhydride copolymer, polyacrylic acid, polyethylenimine, carboxymethyl cellulose, locust bean gum, guar gum, carrageenan, agar, polyvinylpyrrolidone, sulfonated polysulfone, polyethylene oxide, and polyethylene oxide copolymers.

15. The membrane of claim 14 wherein the hydrophilic polymer comprises polyvinyl alcohol

16. The membrane of claim 9, said coating comprising a blend of a polyvinyl alcohol, tannic acid, and an amine-containing surface-active agent.

17. A permselective membrane having improved resistance to fouling, comprising a permselective membrane having a coating on an active surface thereof, the coating comprising a hydrophilic polymer matrix and a polyfunctional phenolic compound.

18. The permselective membrane of claim 17 wherein the coating has been impregnated with a surface-active agent by means of exposure of the membrane to a solution of the surface-active agent.

19. The permselective membrane of claim 18 wherein the surface-active agent comprises an amine containing surfactant.

20. The permselective membrane of claim 19 wherein the polyfunctional phenolic compound comprises tannic acid.
